(19) United States
(12) Patent Application Publication
(10) Pub. No.: US 2010/0169376 A1
(43) Pub. Date: Jul. 1, 2010

(54) VISUAL SEARCH ENGINE FOR PERSONAL DATING

(75) Inventor: Dennis Chu, Fremont, CA (US)

Correspondence Address: Yahoo! Inc.;c/o Frommer Lawrence & Haug LLP, 745 Fifth Avenue, NEW YORK, NY, 10151, US

(73) Assignee: Yahoo! Inc., Sunnyvale, CA (US)

(21) Appl. No.: 12/345,435

(22) Filed: Dec. 29, 2008

(51) Int. Cl. G06F 3/048; G06F 17/30; G06F 7/00

(52) U.S. Cl. 707/780; 715/747; 715/757; 707/E17.032; 707/E17.109

(57) ABSTRACT

Embodiments are directed towards enabling generation of visual search criteria using visual elements for at least within an online dating context. A friend creates a dream date avatar for an intended search result recipient by combining one or more visual search criteria. The dream date avatar embodying the visual search criteria may be sent to other friends, each of which may then modify the search criteria by visually modifying the dream date avatar. Each time a modified dream date avatar is sent over a network, a new search may be performed, with the subsequent search results being sent to the intended search result recipient. The intended recipient may also modify the dream date avatar using visual search criteria resulting in another search to be performed. Moreover, the intended recipient may terminate one or more of the searches to minimize a likelihood of being spammed.

### TECHNICAL FIELD

The present invention relates generally to enabling searches over a network and, more particularly, but not exclusively to enabling a user to employ visual elements to generate and manage search criteria.

### BACKGROUND

Tremendous changes have been occurring in the Internet that influence our everyday lives. For example, in today's society, one of the first activities that a user might perform when turning on their computers is to start up their search tools. In fact, use of Internet search tools have been so common, that it is not uncommon to see a person on a bus, train, or even a boat, to be using their mobile devices to search for merchants, restaurants, music, businesses, friends, dates, or the like.

Today's searching services enable users to perform searches by providing one or more keywords as search criteria. Typically, the search services seek to match the keywords to product names, brands, merchants, music, dating profiles, or the like. In some search services, the user may be provided with a set of search criteria from which to select to perform their searches.

For example, online dating search services typically require a prospective participant to select from a list of search criteria, such as gender, age, ethnicity, body type, profession, interests, and the like. After the participant has selected such criteria for someone they are looking for, the search service performs a search and may return a result of candidates whose profiles substantially match at least some of the selected criteria.

However, the list of search criteria that many online dating search services typically use are represented by a long list of forms, check boxes, radio buttons, and similar elements from which a participant is expected to select their search criteria. Some of these lists might take a participant hours, if not days to complete. The result is that many users may elect not to participate in such onerous pre-search activities. Moreover, if users do not complete the search criteria activities or only provide partial criteria, then the results of their searches are more likely to lead to dissatisfaction with the service. Therefore, there is a desire to improve at least the online dating search experience. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical flow diagram generally showing one embodiment of an overview process for employing graphical elements representing search criteria to generate visual representations of the search criteria for use in performing online searches;

FIG. 5 illustrates a logical flow diagram generally showing one embodiment of an overview process for managing online search results from visual representations of search criteria; and

FIGS. 6-15 illustrate various embodiments of screen shots showing aspects of using visual elements to manage online searches for a non-limiting example of online dating.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated the present invention is directed towards relieving at least some of the search ‘pain points’ arising from generating search criteria using input forms, lists, and the like, as described above. As such, embodiments of the invention are directed towards providing an interface with visual elements for which a search user may generate a visual representation of search criteria. In one embodiment, the visual elements may be employed for use in generating a visual representation of search criteria within an online dating context. However, the invention not limited to the online dating context, and employing visual elements as described herein to generate visual representations of search criteria may be used within other search contexts, including, but not limited to, employment searches, product and/or service searches, or the like.

Embodiments of the invention are further directed towards allowing friends to generate visual representations of search criteria for each other using visual elements. As used herein, the terms “visual elements,” and “visual search criteria,” refer to graphical components or elements useable for selecting and/or defining a set of one or more search criteria. In one embodiment, the visual elements or visual search criteria may be tagged, labeled, or otherwise linked to one or more keywords that may then be used to perform a keyword search for one or more results. As used here, the term “visual representation” of search criteria is any graphical or visual representation of the search criteria. In one embodiment, such visual representation is embodied in an avatar that visually represents one or more search criteria. However, the visual representation may also include a scene, or other visual elements around, held by, on, or otherwise, in proximity to the avatar.

In the context of online dating, friends may create a ‘dream date” by combining visual search criteria into a dream date avatar, and emailing the visual search criteria as a dream date avatar and/or scene, as a visual representation, among each other, and/or to the intended recipient of the search results. Sending the visual search criteria as a dream date avatar and/or scene between friends enables the friends to quickly view the search criteria and to visually modify the search criteria. By employing visual search criteria the invention may increase opportunities for finding desirable search results. Moreover, by allowing a recipient's friends to generate the search criteria, a wider variety of different searches may be performed for the recipient, thereby increasing a likelihood that the recipient of the results may find a desirable date. The search results may be sent to the intended recipient, and/or other friends, using any of a variety of mechanisms, including email, web links, Multimedia Messaging Service (MMS), or the like.

In one embodiment, each time a modified visual search criteria in the form of a dream date avatar is sent over a network a new search may be performed with the subsequent search results being send to the intended recipient. In one embodiment, the intended recipient may also modify the dream date avatar using visual search criteria, resulting in another search being performed. Moreover, the intended recipient may terminate one or more of the searches so as to minimize a likelihood of being spammed.

### Illustrative Operating Environment

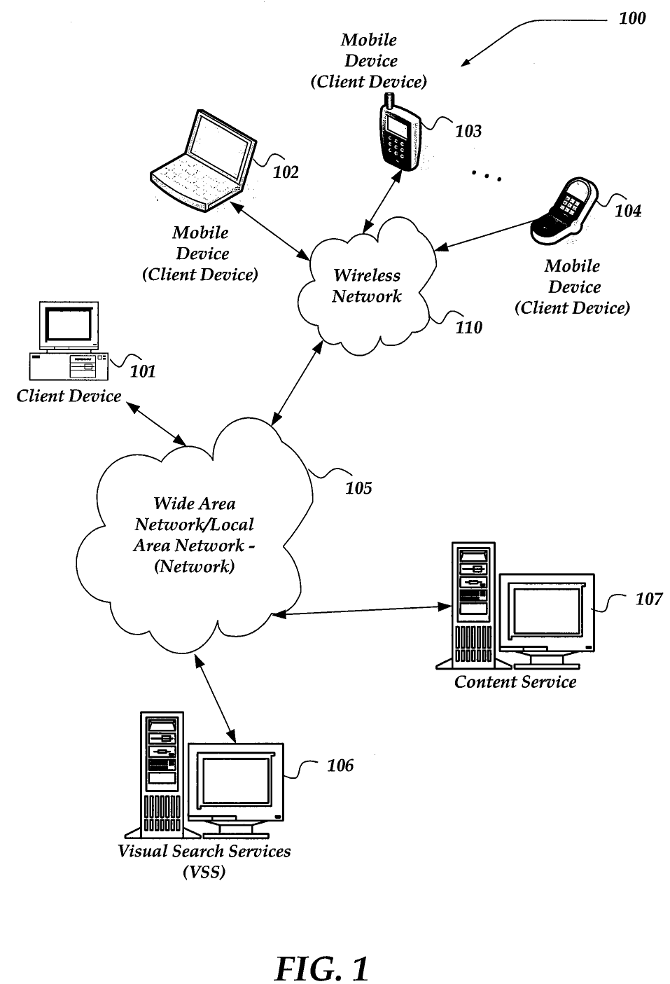

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, Visual Search Services (VSS) 106, client devices 101-104, and content service 107.

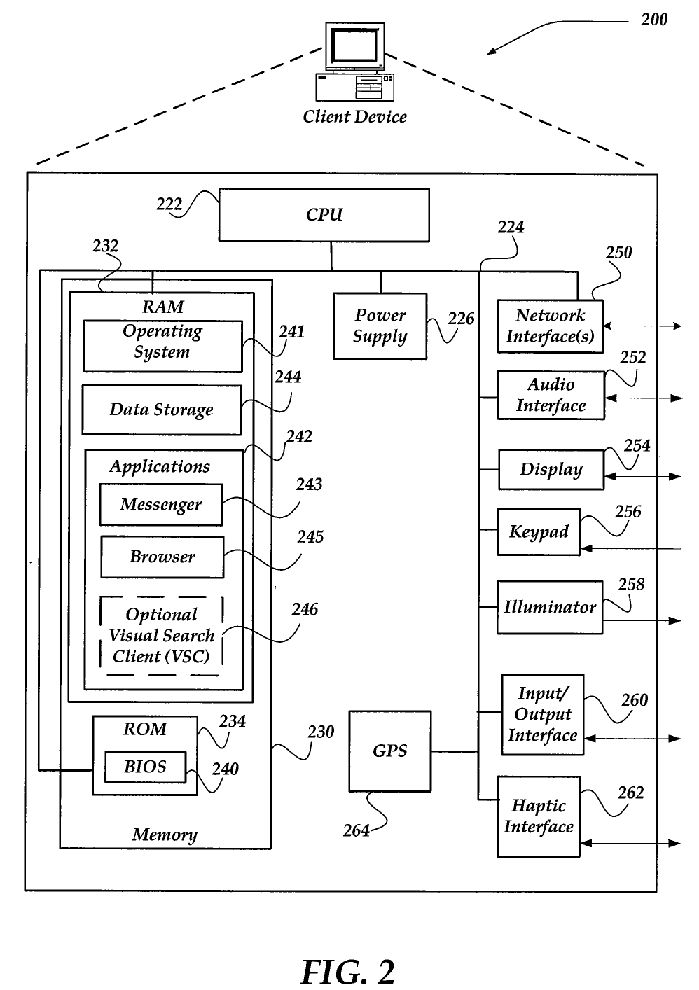

One embodiment of client devices 101-104 is described in more detail below in conjunction with FIG. 2. Generally, however, client devices 102-104 may include virtually any portable computing device capable of receiving and sending a message over a network, such as network 105, wireless network 110, or the like. Client devices 102-104 may also be described generally as client devices that are configured to be portable. Thus, client devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, client devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Client device 101 may include virtually any computing device capable of communicating over a network to send and receive information, including social networking information, performing graphically generated search queries, or the like. The set of such devices may include devices that typically connect using a wired or wireless communications medium such as personal computers, multiprocessor systems, microprocessor-based or programmable consumer electronics, network PCs, or the like. In one embodiment, at least some of client devices 102-104 may operate over wired and/or wireless network.

A web-enabled client device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the client device may employ the browser application to perform a graphically generated search over a network. However, another application may also be used to perform a search over the network.

Client devices 101-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, client devices 101-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a network packet, or the like, sent to VSS 106, content service 107, or other computing devices.

Client devices 101-104 may further be configured to include a client application that enables the end-user to log into an end-user account that may be managed by another computing device, such as content service 107, VSS 106, or the like. Such end-user account, for example, may be configured to enable the end-user to receive subscribe to one or more search activities, including for example employment searches, online dating searches, product and/or service searches, or any of a variety of other social networking activities. However, participation in various search and/or other networking activities, may also be performed without logging into the end-user account.

As such, client devices 101-104 may enable a user to perform a search query for content, employment, an online dating candidate profile, or the like, wherein such information being searched may reside on, for example, content service 107. Client devices 101-104 might employ VSS 106 to generate a search using graphical elements that visually represent one or more search criteria. In one embodiment, a user of client devices 101-104 may perform the search by visually selecting one or more graphical elements representing various search criteria. In one embodiment, the graphical elements may represent various tangible search criteria such as a hair color, skin color, weight, height, or the like, of a potential online dating candidate. However, the graphical elements might also represent various intangible search criteria, including, but not limited to a candidate's education level, desire for children, financial status, activities of interest, hobbies, or the like.

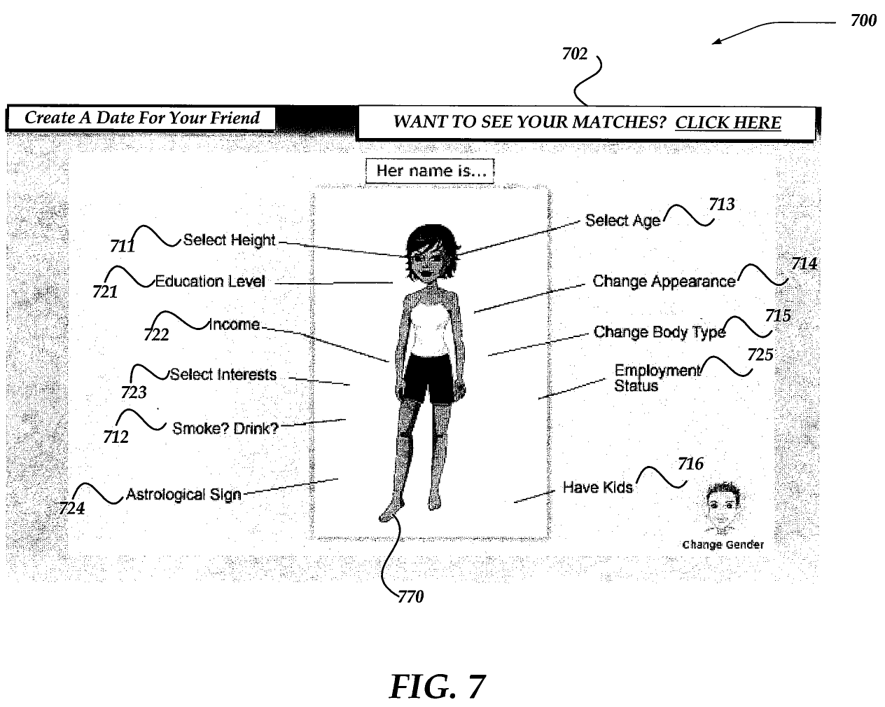

In a non-online dating context, the graphical elements might represent a product and/or service for which a search is to be performed. Tangible search criteria might be physical characteristics of the product/service, while intangible search criteria might represent a price, a quality, a desired shipping or delivery date of the product/service, or the like. Examples of various graphical elements representing tangible and/or intangible search criteria are described in more detail below in conjunction with FIGS. 7-15.

By visually selecting various graphical elements, the user may be able to generate a visual representation of the search criteria. Such visual representation is directed towards enabling the user to quickly what the search criteria is intended to embody as a possible result. In one embodiment, the visual representation might include an avatar representing, for example, an online dating candidate. In one embodiment, the graphical elements might further include representations of search criteria embodied in background scenes in which the avatar may be displayed, such as a vacation scene, a work scene, a home scene, or the like. The scenes might represent hobbies, education, activities, or other aspects desired of the online candidate.

By generating the avatar within a scene based on the graphical elements, the user might readily visualize what the online dating candidate might look like as well as other aspects of the online dating candidate. Using graphical elements enables the invention to embody the concept that “a picture is worth a thousand words.” Thus, the user may see a possible result of the search, and if the avatar does not appear to represent a desired search result, the user may modify the avatar by selecting and combining different graphical elements.

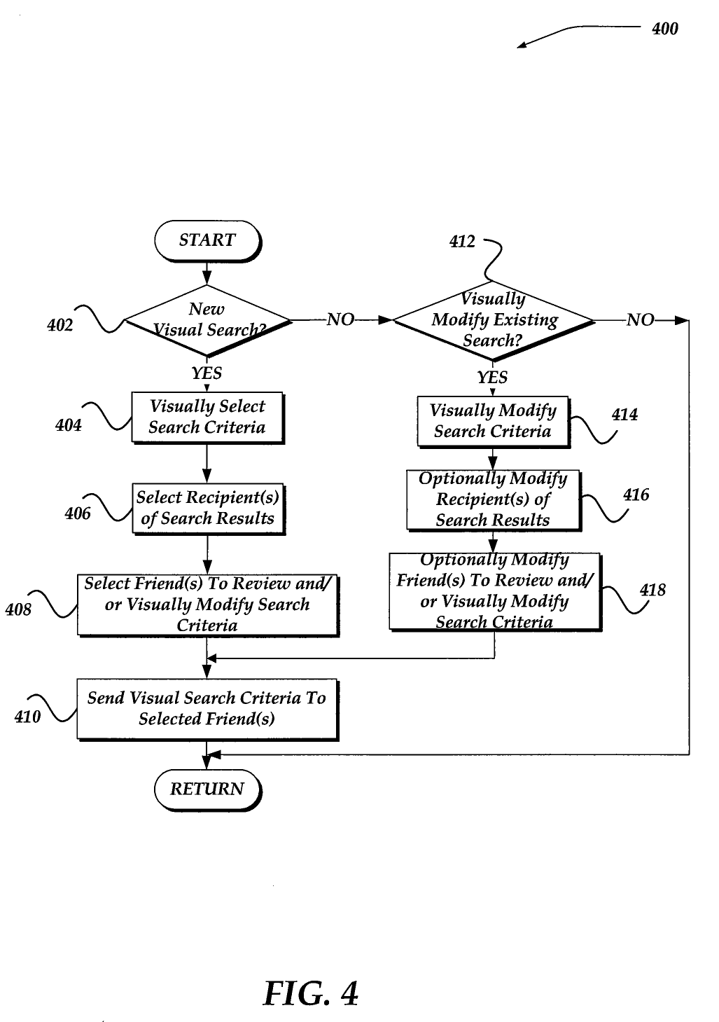

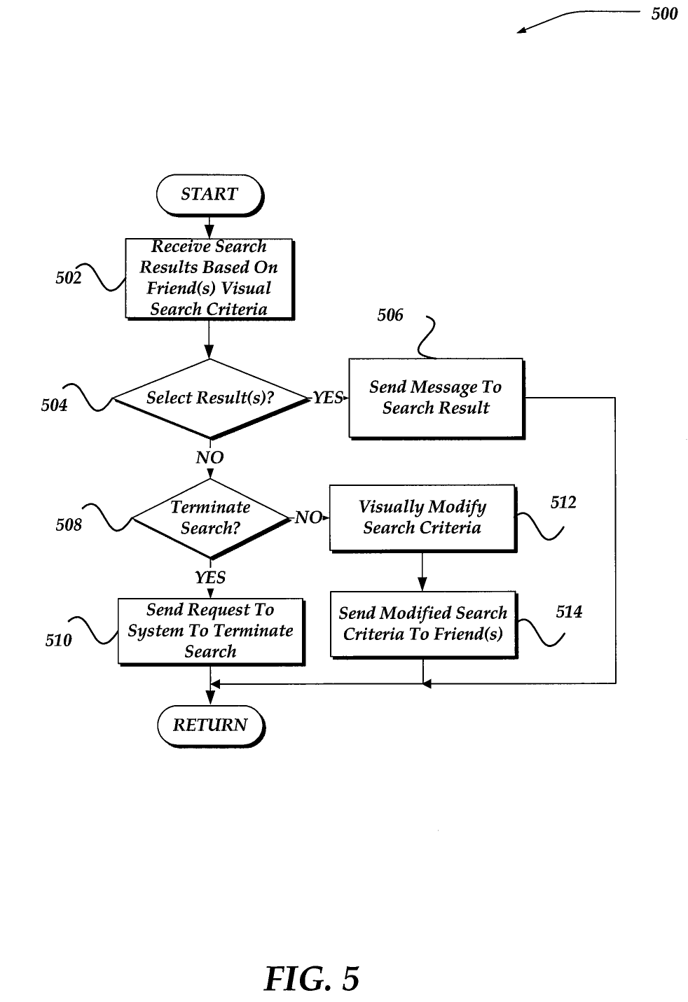

In any event, the user may request VSS 106 to perform the search and provide results of the search to the user. However, in another embodiment, the user might generate the visual representation for use in performing a search for another user. For example, use of embodiments enables a user to create a ‘viral’ effect that allows one's friends to create and send to other friends visual representations of search criteria for someone else. Such capability may be based on the concept that one's friends may know you better than yourself. Thus, one's friends may visually create the visual representations used to perform searches. The results of the searches may then be provided to an intended search recipient. Moreover, the ‘viral’ effect may arise by allowing friends to send the visual representation to each other, allowing them to modify the visual representation and generate additional searches, for which the results are then also sent to the intended search recipient. Processes further describing graphically generating visual representations of search criteria are described in more detail below in conjunction with FIGS. 4-5.

Wireless network 110 is configured to couple client devices 102-104 and its components with network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple network devices with other computing devices, including, VSS 106, content service 107, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

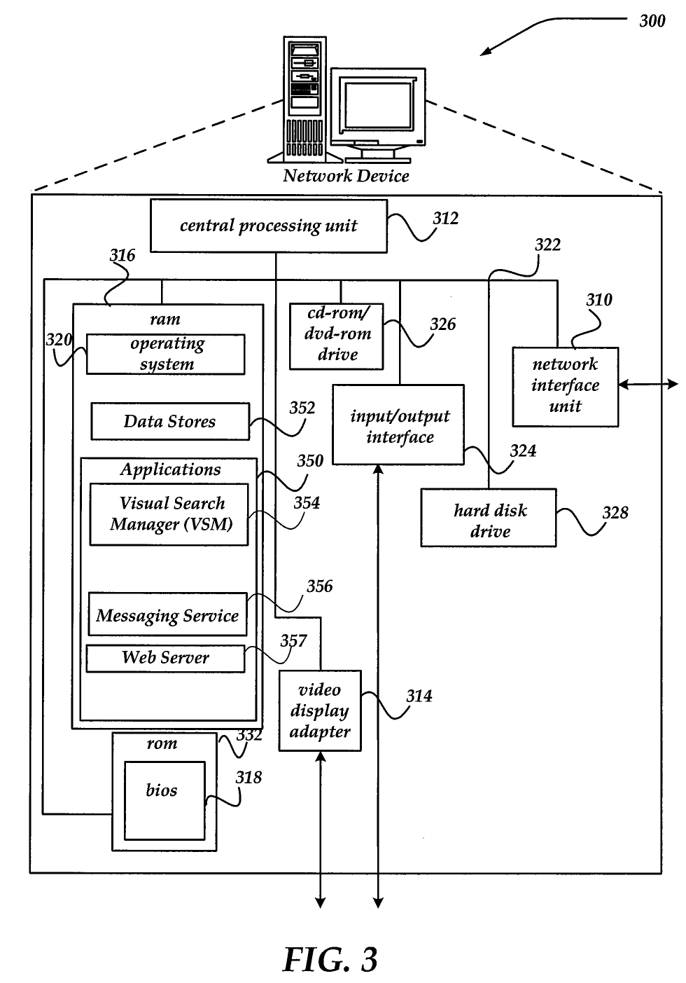

One embodiment of VSS 106 is described in more detail below in conjunction with FIG. 3. Briefly, however, VSS 106 may include any computing device capable of connecting to network 105 to provide a graphical user interface to client devices 101-104 for use in generating and/or otherwise managing search queries using graphical elements to select various search criteria.

VSS 106 may receive a request from a user to generate a search query using graphical elements. VSS 106 may graphically display one or more elements useable to select one or more search criteria. In one embodiment, a first friend of an intended search result recipient might select one or more of the graphically displayed elements that represent the search criteria. VSS 106 may then combine the selected graphical elements into a visual representation. In one embodiment, the visual representation might include an avatar. In one embodiment, the avatar might be represented within a scene that further visually represents other search criteria using other graphical elements.

In one embodiment, keywords, tags, labels, or the like, might be associated with the graphical elements. Thus, selecting and combining the graphical elements may result in selection and/or combining of the keywords, tags, labels, or the like, into a search query useable over one or more data stores, such as might reside on content service 107. In one embodiment, the keywords, tags, labels, or the like, might not be displayed to a user. However, in another embodiment, at least some of the keywords, tags, labels, or the like, might be displayed with an associated graphical element. For example, when a user is displayed various graphical elements representing hair color, the hair colors might be visually displayed, along with text further indicating that the hair color might be black, brunette, blond, gray, or the like. While the text might also be displayed, the user may still select the graphical element representing the desired hair color, or other search criteria, rather than selecting the text representation.

VSS 106 may receive information indicating for whom to send a result of the search query. In one embodiment, the information might include an account identifier, an email address, a user name, an alias, or other unique network address. In one embodiment, the search results might be sent to more than one intended search result recipient. In any event, VSS 106 may perform the search based on the visual representation, and provide results of the search to the one or more intended search result recipient(s). VSS 106 may send the results to the one or more intended search result recipient(s) using any of a variety of communication mechanisms, including, but not limited to email, sending to a web page, using MSS, IM, or the like.

In one embodiment, VSS 106 may operate within another social networking system. For example, in one embodiment, VSS 106 may provide visual search interfaces, and/or visual search results within a user's facebook context. However, the invention is not so constrained. For example, in another embodiment, VSS 106 might provide to client devices 101-104 a downloadable application, widget, or the like, useable to generate a visual representation of search criteria and/or to perform the search query request. VSS 106 may also be integrated with any other application, such as a product/service application within content service 107, or operate as a standalone system within VSS 106.

VSS 106 may also enable an intended search result recipient to manage receipt of one or more search results. For example, VSS 106 may enable the recipient to terminate a search activity, such that additional search results are not sent to the intended recipient. In this manner, the intended recipient might prevent receiving spam, or other undesired messages. VSS 106 may employ a process such as described below in conjunction with FIGS. 4-5 to perform at least some of its actions.

Devices that may operate as VSS 106 include various network devices, including, but not limited to personal computers, desktop computers, multiprocessor systems, microprocessor-based or programmable consumer electronics, network PCs, servers, network appliances, and the like.

Content service 107 represents any of a variety of network devices to provide searchable content and/or services accessible by client devices 101-104. Such services include, but are not limited to searchable merchant sites, educational sites, news sites, personal sites, music sites, video sites, blog sites, vlog sites, online dating sites, and/or any of a variety of social networking sites. In fact, content service 107 may provide virtually any content and/or service over which a user of client devices 101-104 may want to perform a search. For example, content service 107 might represent an online dating service for which a user might provide search criteria and have results generated from a search query that represents one or more profiles of online dating candidates.

Devices that may operate as content service 107 includes personal computers, desktop computers, multiprocessor systems, microprocessor-based or programmable consumer electronics, network PCs, servers, and the like.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store social networking information including address books, buddy lists, aliases, user profile information, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications 242 may include, for example, messenger 243, browser 245, and optional Visual Search Client (VSC) 246.

Browser 245 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may be employed.

In one embodiment, browser 245 may be configured to enable access to a graphical user interface provided by VSS 106 of FIG. 1. In one embodiment, a user of client device 200 may input to the search application a variety of visual elements useable to generate a visual representation of search criteria for use in obtaining a search results. In one embodiment, the user may employ browser 245 to identify one or more recipients of the search results. In another embodiment, browser 245 may further be employed to enable the user to send the visual representation to others such as friends for use in modifying the visual representation and thereby modify the search criteria useable for performing other searches.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, RSS feeds, and/or the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols, including, but not limited to various push and/or pull mechanisms for client device 200. In one embodiment, messenger 243 may interact with browser 245 for managing messages.

VSC 246 represents a downloadable application, widget, or the like, useable to provide a graphical user interface for display on client device 200. The graphical user interface may display graphical elements useable for generating a visual representation, such as an avatar and/or a scene that is useable for performing a search. However, VSC 246 may represent an optional component, and as such, such visual search capabilities may be performed using another component such as browser 245 accessing a remote network device, such as VSS 106 of FIG. 1, or the like.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may represent, for example, VSS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer-readable storage media. Computer-readable storage media may include volatile, nonvolatile, removable, and non-removable media implemented in any method or technology for storage of information, such as computer readable instructions, data structures, program modules, or other data. Examples of computer readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

As shown, data stores 352 may include a database, text, spreadsheet, folder, file, or the like, that may be configured to maintain and store graphical elements useable to generate a visual representation of search criteria; user interface elements; avatars, tags, labels, or the like, that may be associated with one or more graphical elements; graphical elements, search results; user account identifiers, email addresses, IM addresses, and/or other network addresses; or the like. In one embodiment, at least some of data store 352 might also be stored on another component of network device 300, including, but not limited to cd-rom/dvd-rom 326, hard disk drive 328, or the like.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Web server 357, messaging server 356, and Visual Search Manager (VSM) 354 may also be included as application programs within applications 350.

Web server 357 represent any of a variety of services that are configured to provide content, including messages, over a network to another computing device. Thus, web server 357 includes for example, a web server, a File Transfer Protocol (FTP) server, a database server, a content server, or the like. Web server 357 may provide the content including messages over the network using any of a variety of formats, including, but not limited to WAP, HDML, WML, SMGL, HTML, XML, cHTML, xHTML, or the like.

In one embodiment, web server 357 may provide access to various web content, services, or the like, including, but not limited to a user's face book web content, content/services accessible from content services 107 of FIG. 1, or the like.

Web services 357 may also interact with VSM 354 for use in providing one or more user interfaces useable for managing searches using visual representations of search criteria.

Messaging server 356 may include virtually any computing component or components configured and arranged to forward messages from message user agents, and/or other message servers, or to deliver messages to a local message store, such as data store 354, or the like. Thus, messaging server 356 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like. Messaging server 356 may also be managed by one or more components of messaging server 356. Thus, messaging server 356 may also be configured to manage SMS messages, IM, MMS, IRC, RSS feeds, mIRC, or any of a variety of other message types. In one embodiment, messaging server 356 may enable users to initiate and/or otherwise conduct chat sessions, VOIP sessions, or the like. Messaging server 357 may also receive visual representations from VSM 354 for use in sending messages that include the visual representations to one or more other users. Messaging server 357 might also be employed to provide search results based on the visual representations to one or more intended search result recipients. Thus, in one embodiment, messaging server 356 may be configured to interact with web server 357 and/or VSM 354 for use in messages associated with searches using visual representations of search criteria.

VSM 354 is configured to enable a user to create and otherwise manage searches using graphical elements to generate a visual representation of search criteria. In one embodiment, VSM 354 is directed towards online dating contexts; however, the invention is not so limited, and virtually any search wherein the search criteria may be represented by selectable graphical elements may be employed.

VSM 354 provides, in one embodiment a user a display of one or more graphical elements, each graphical element representing one or more search criteria. The friend may then select from the graphical elements to generate a visual representation of the search criteria. In one embodiment, VSM 354 is configured to enable the user to upload, or otherwise link graphical elements from another source. For example, where a user would like to represent a search criteria using a photograph, or other graphical content item, the user may, in one embodiment, upload or otherwise provide the graphical content item to VSM 354. In one embodiment, the user might further specify the search criteria associated with the provided graphical content item. For example, the user might provide tags, labels, or other information that may be used as keywords for a search. However, the invention is not so limited. For example, in one embodiment, an analysis might be performed by VSM 354 to determine if a tag, or other label is currently associated with the provided graphical content item. If so, VSM 354 may employ those tags, or other labels for keywords in a search. In still another embodiment, VSM 354 might perform an analysis of the graphical content item to attempt to recognize its content. Once the content is recognized, VSM 354 might search a data store, such as 352, the internet, or the like, to find keywords, or the like, useable as search criteria for the recognized content. For example, where a user uploads a photograph of a new car, VSM 354 might scan the photograph, and determine that the photograph includes a car. VSM 354 might further attempt to determine characteristics of the car, including, for example, its make, year, style, or the like. VSM 354 might further attempt to determine a current price associated with the car. VSM 354 might then employ keywords based on the determined characteristics for use in performing a search.

VSM 354 further receive one or more names and/or addresses to which a result of the search query might be provided, that is, the intended search result recipients. VSM 354 may also receive one or more names and/or addresses to which the visual representation might be sent for these additional recipients to be able to modify the search criteria using graphical elements.

VSM 354 may also allow the intended search result recipients to receive and/or modify the visual representation of the search query. In one embodiment, VSM 354 may further allow the intended search result recipients to terminate one or more searches. In this manner, the intended search result recipients may avoid receiving undesired messages that they might consider as spam.

VSM 354 may also enable the user developing the visual representation for a search to view possible results of the search. In this manner, the user might be able to use such results to further modify the search criteria.

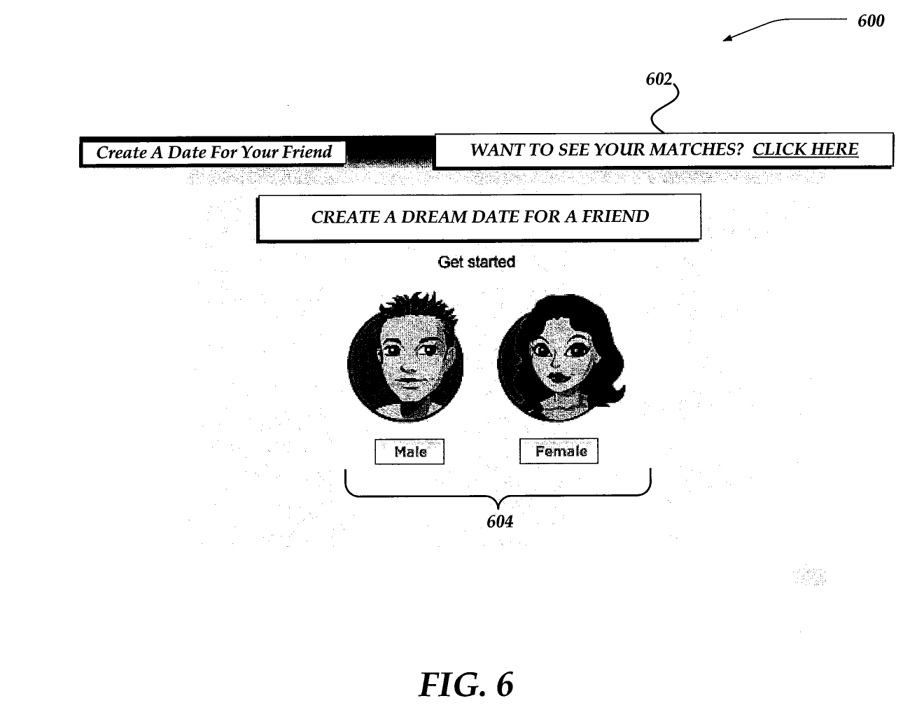

VSM 354 may provide a variety of graphical user interfaces for use in creating and/or sending visual representations of search criteria. VSM 354 may employ, in one embodiment, interfaces such as described in more detail below in conjunction with FIGS. 6-15. Further, VSM 354 may employ processes such as described below in conjunction with FIGS. 4-5 to perform at least some of its actions.

### Generalized Operation

The operation of certain aspects of the invention will now be described with respect to FIGS. 4-5. FIG. 4 illustrates a logical flow diagram generally showing one embodiment of an overview process for employing graphical elements representing search criteria to generate visual representations of the search criteria for use in performing online searches. Process 400 of FIG. 4 may be implemented within VSS 106 of FIG. 1.

Process 400 begins, after a start block, at decision block 402, where a determination is made whether a request is received to perform a new visual search. In one embodiment, a request to perform a new visual search may be determined by receiving a user selection to display a particular user interface at a client device. For example, in one embodiment, a user might select a link, or the like, that enables a display of interface 600 of FIG. 6. The user may then select to perform a new visual search by selecting a gender 604. In one embodiment, the user performing such actions may be a friend of an intended search result recipient. That is, a friend may select to create a visual representation of search criteria for another friend. However, the invention is not so limited, and the user may also create and/or perform searches for them self. In any event, if the user selects to perform a new visual search, processing proceeds to block 404; otherwise, processing flows to decision block 412.

At block 404, the user may then be provided with graphical elements for which the user may then select to create a visual representation of search criteria. Using graphical elements to create a visual representation is described in more detail below in conjunction with FIGS. 7-15. Briefly, however, the user may select from representations of various tangible and/or intangible search criteria, including, but not limited, for online dating contexts, height, education level, income, interests, age, appearance, body type, employment status, or the like. Selection of various graphical elements representing search criteria results in a visual representation of the search criteria. For example, in the online dating context, an avatar representing a dream date might be created. In one embodiment, the avatar might be placed within a scene that further visually represents various search criteria, as discussed below.

Processing continues next to block 406, where the user may select one or more intended recipients of the search results. In one embodiment, the user may specify a name, an alias, an account identifier, a network address, or the like, of the one or more intended recipients.

Processing flows next to block 408, where the user may also specify one or more friends to receive the visual representation of the search criteria. This list of friends can be provided using any of a variety of mechanisms. For example, the user might specify that at least a subset of a user's buddy list, address book, IM list, or the like, be used to specify the list of friends. In another embodiment, the user might provide the list through a mechanism such as placing the visual representation of the search criteria in a location where a subset of friends may be enabled to access it. For example, placing the visual representation on the user's website, Flicker page, blog, a social networking site, or the like, may then allow selected friends to access the visual representation. In one embodiment, the list of friends may then be generated, automatically, without additionally actions by the user. By sending the visual representation to various friends of the user and/or of the intended search results recipients, a viral effect may be created that allows one's friends to modify the dream date (or other visual representation of the search criteria). This viral effect could go back and forth between friends and/or other friends to generate additional visual representations of different search criteria. In this way, the intended recipients of the search results might have increased searches performed for them, thereby increasing online dating opportunities (or other search opportunities).

Processing then flows to block 410, where the user may then select to have the visual representation of the search criteria sent to the one or more selected friends. In one embodiment, when the visual representation is sent to the other friends, a search may also be performed. The results of the search may then be sent to the selected one or more intended recipients of the search results. In another embodiment, the invention might initially perform the search, and then based on changes to a data store, a defined elapsed time period, or based on other criteria, the invention might perform another search. In this way, in one embodiment, the intended recipient might receive a plurality of search results for a given visual representation.

In one the friends and/or intended recipient of the search results might receive the results and/or visual representation over email. However, the invention is not so limited, and other communication mechanisms might be employed, including, but not limited to SMS, IM, messages embodied within a web page, or the like. In any event, processing then returns to a calling process to perform other actions.

At decision block 412, however, a determination is made whether the user has selected to modify an existing visual representation. If so, processing may flow to block 414; otherwise, processing may return to a calling process to perform other actions.

At block 414, the user may view an existing visual representation, and select graphical elements to modify the visual representations. Continuing to block 416, the user may optionally modify the recipients of the search results. For example, in one embodiment, the user may select to add and/or delete intended recipients of the search results. Moving to block 418, the user may optionally also modify a list of other friends for which the visual representation might be sent. Processing then continues to block 410.

FIG. 5 illustrates a logical flow diagram generally showing one embodiment of an overview process for managing online search results from visual representations of search criteria. Process 500 of FIG. 5 may be implemented within VSS 106 of FIG. 1, wherein various interfaces may be provided to one or more of client devices 101-104 of FIG. 1.

Process 500 of FIG. 5 begins, after a start bloc, at block 502, where an intended recipient of search results from a visually generated search query receives a set of search results. In one embodiment, the results may be received via email. However, other mechanisms, including those identified above, may be used.

Processing flows next to decision block 504, where the recipient may select one or more of the results for consideration. For example, in one embodiment, the recipient might notice an online dating candidate's profile of which the recipient might be interested. If so, processing flows to block 506, where the recipient might proceed to contact the candidate. Processing then may return to a calling process to perform other actions.

If however, the recipient does not select one of the results, processing flows to decision block 508, where a determination is made whether the recipient selects to terminate searches performed based on the visual representation associated with the received results. If so, processing flows to block 510, where the recipient may specify that future searches using the associated visual representation are to be terminated. In this manner the recipient may minimize a likelihood of receiving undesired results. Processing then returns to a calling process to perform other actions.

If the recipient does not select to terminate the search, the user might instead select to modify the search criteria using graphical elements to modify the visual representation of the search criteria. If so, processing flows to block 512, where the user selects one or more modification to the visual representation. Processing then continues to block 514, where the modified visual representation may then be submitted for performing a search. In addition, the recipient may also select friends to send the modified visual representation, and/or select other intended recipients for the search results. In this manner, the recipient may then participate in the viral effect of providing modifications to the search criteria. It is noted, that in one embodiment, the recipient might select not to modify the visual representation, nor select one of the candidates, nor terminate the searches. In this instance, and/or from block 514, the process may also return to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative Non-Limiting, Non-Exhaustive Graphical Interfaces

Certain aspects of the invention will now be described with respect to graphical user interfaces useable for managing visual representations of search criteria. FIGS. 6-14 illustrate various embodiments of screen shots showing aspects of using visual elements to manage online searches for a non-limiting example of online dating. It is noted that while the following illustrates represent searches performed within an online dating context, other search contexts may also employ visual representations of search criteria. Thus, the invention is not constrained to merely online dating contexts.

Moreover, not all the components illustrated in FIGS. 6-15 may be required to practice the invention, and variations in the arrangement and type of the components may be made without departing from the spirit or scope of the invention. In any event, FIG. 6 illustrates one embodiment of an interface useable to initiate a new search and/or modify search criteria visually for an existing search. As shown, interface 600 shows that a user may create a dream date for a friend (or themselves) by selecting a gender 604 of the dream date. In one embodiment, selection of the gender may result in moving to interface 700 of FIG. 7.

Also illustrated in interface 600 is a selection indicator 602 that enables the user to see potential matches for the user. Thus, in one embodiment, where the user's profile might be available, a search may be performed for candidate profiles matching the user's profile. Thus, for the user, in one embodiment, search results might be generated automatically for the user.

In any event, where the user intends to create a visual representation for use in searches for a friend, interface 700 of FIG. 7 may be displayed at the user's client device. As shown, interface 700 may provide a plurality of selections 711-716 representing tangible search criteria. Such tangible search criteria may include, but not be limited to height, whether the candidate smokes, drinks, or the like, as well as age, appearance, body type, has children, or the like. Interface 700 further may display a plurality of other selections 721-725 that may represent intangible search criteria, such as an education level, income, astrological sign, employment status, or the like. The invention is not limited to these selections and/or other selections, and still others may also be displayed, without departing from the scope of the invention.

In one embodiment, selections might represent, for example, a geographic proximity to the intended search result recipient. Thus, a plurality of selections may be provided illustrating various maps, or other visual illustrations that may represent a distance between a candidate and the search result recipient. For example, in one embodiment a geographic location of the search result recipient may be automatically determined based on stored profile of the intended search result recipient. Then, one of the plurality of selections might represent proximity. Selection of proximity might provide a map indicating a location of the recipient and/or a distance on the map where an avatar is placed illustrating possible ranges of distances between the recipient and a candidate from the search. However, other mechanisms may also be used to visually represent proximity.

Also shown may be an avatar 770 for which one or more of the graphical elements the user selects may be applied. In one embodiment, the user may also be provided a selection indicator 702 useable to view a result of a search performed based on the visual representation of the search criteria.

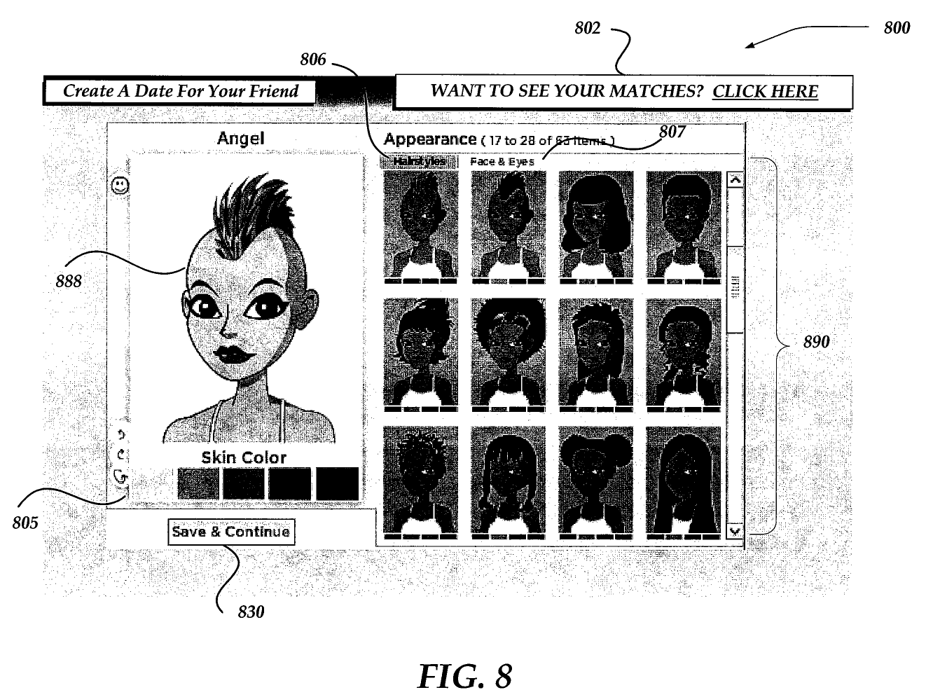

FIG. 8 illustrates interface 800 useable to enable the user to select various graphical elements representing search criteria. For example, as illustrated, the user might select skin color 805, hair styles 806 and/or face/eyes 807. In one embodiment, the user might be presented with a plurality of graphical elements 890, from which the user might select for modifying avatar 888. In one embodiment, the user might scroll through the plurality of graphical elements 890. In one embodiment, the user might drag a selected graphical element onto avatar 888 to select the represented search criteria. In another embodiment, the user might highlight one or more of the plurality of graphical elements 890 to select them for modifying avatar 888. Selection indicator 802 enables the user to view results of a search for the user, and/or based on the visual representation.

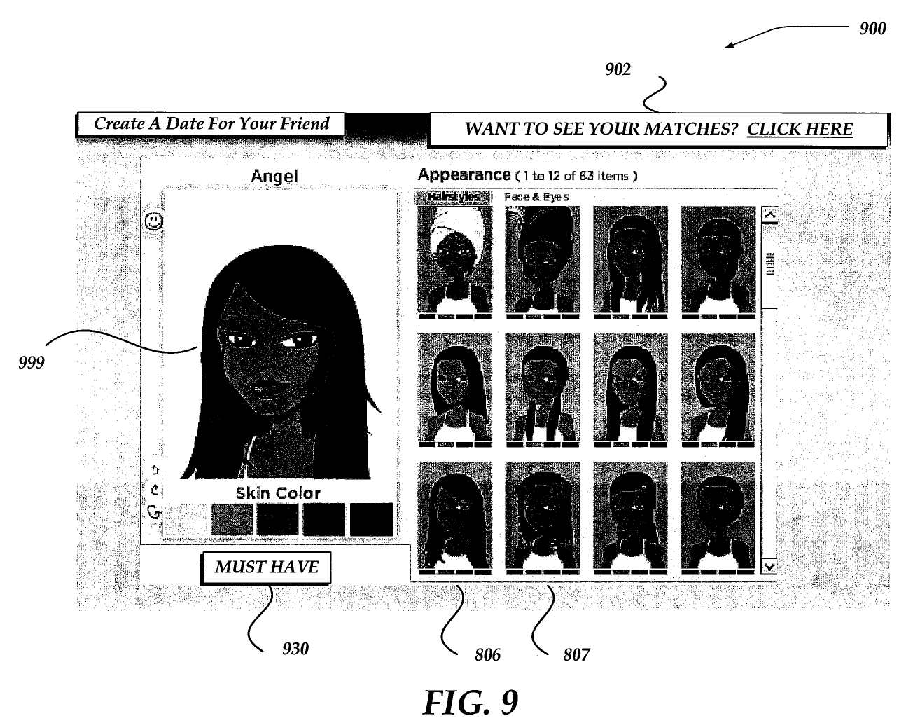

FIG. 9 illustrates interface 900 where the user may select various hair colors 806, face/eyes 807 for which to modify avatar 999. At virtually any interface where the user is selecting/modifying graphical elements representing search criteria, the user may also select a graphical element to represent a MUST HAVE search criteria. Thus, in one embodiment, the user might be provided with a priority indicator 930 for which the user may employ to specify whether the search criteria is a must have, a desirable, or the like. Although priority indicator 930 is illustrated using text, the invention is not so limited. For example, a must have criteria might be selected by selecting a RED indicator, while a desirable criteria might be selected by selecting a YELLOW indicator, or the like. Thus, other graphical elements may also be used to identify whether one or more search criteria have a different priority over another search criteria.

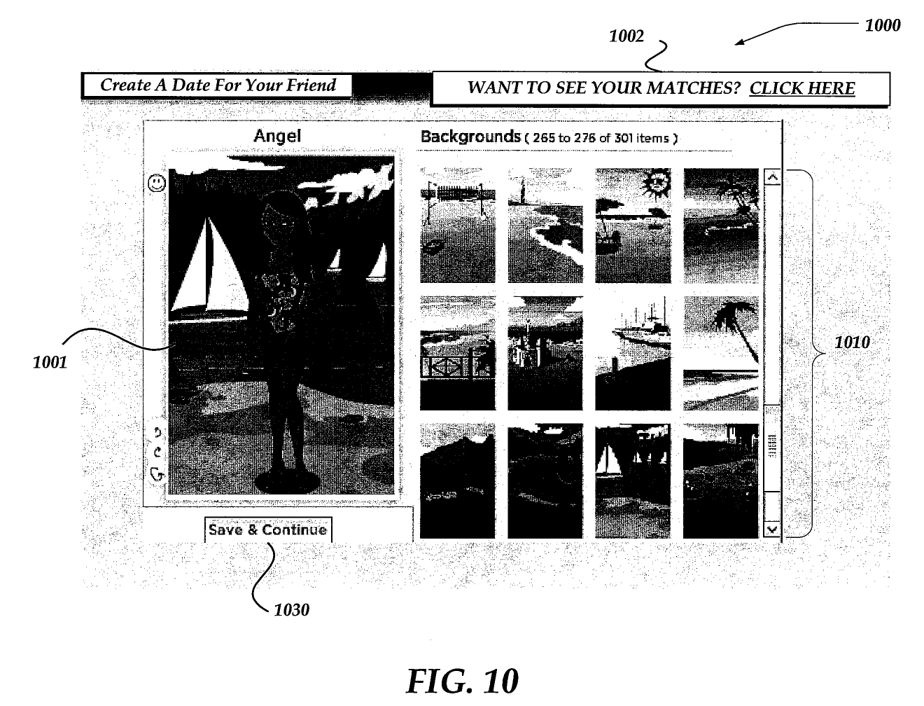

FIG. 10 illustrates interface 1000 useable to select various backgrounds 1010 that may visually represent other search criteria. For example, such backgrounds 1010 might represent desired activities, hobbies, or the like, in which the candidate might participate. For example, scene 1001 might represent that the candidate likes to boat, swim, or the like. In one embodiment, as noted elsewhere, the user may also be enabled to add a photograph, or the like, to backgrounds 1010, that may represent other search criteria.

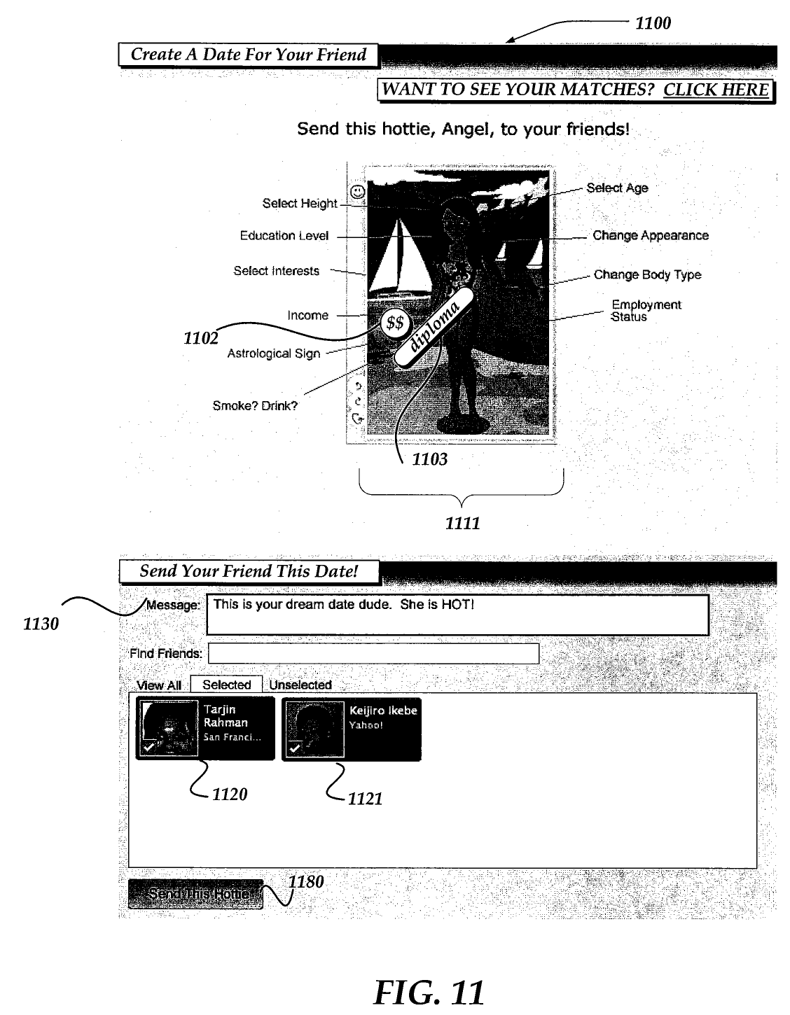

FIG. 11 illustrates interface 1100 that discloses that a user might be provided various graphical elements to represent intangible search criteria, such as income 1102, education 1103, or the like. As further illustrated the user may select one or more intended search result recipients 1120-1121, for which the visual representation 1111 may be used to perform searches. The user may include a message 1130 in a message that is to be sent to one or more friends of the recipients 1120-1121. When the user is ready, the user may select send indicator 1180 to initiate a search and to send the visual representation and message to the one or more friends.

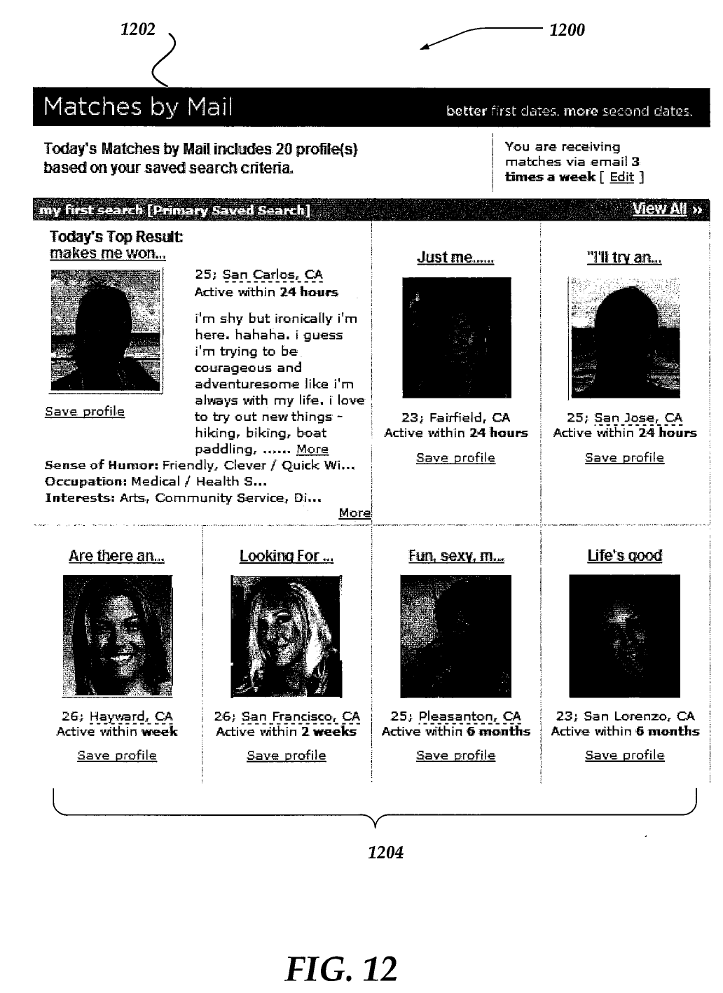

FIG. 12 illustrates one embodiment of message interface 1200 showing a search results sent to one or more of the intended search results recipients. The recipient of the search result may then select one or more of candidate profiles 1204 to initiate a communications, learn more about the candidate, save the profile, or the like. As shown, the message interface 1200 may be sent by email 1202; however, other mechanisms may also be used.

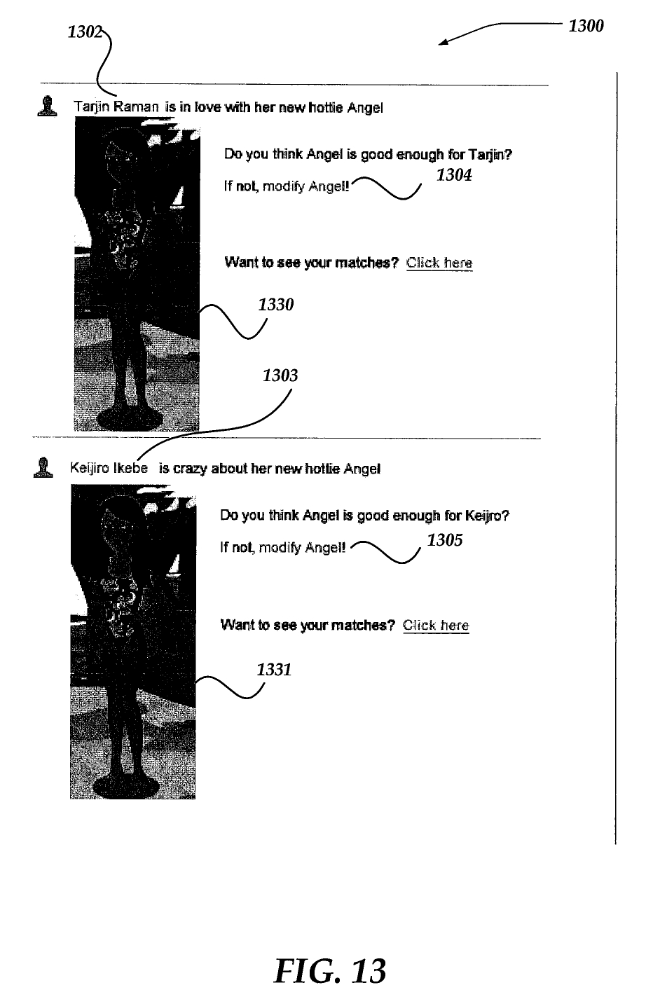

FIG. 13 illustrates one embodiment of a message, web page, or the like, showing what might be sent to one or more of the friends of the intended search result recipient. As illustrated, the friend might receive messages indicating from whom the search is performed 1202-1203, and showing visual representations 1330-1331 of the search criteria. The friend may also be provided with an opportunity to modify the visual representations 1330-1331 using a selection indicator 1304-1305.

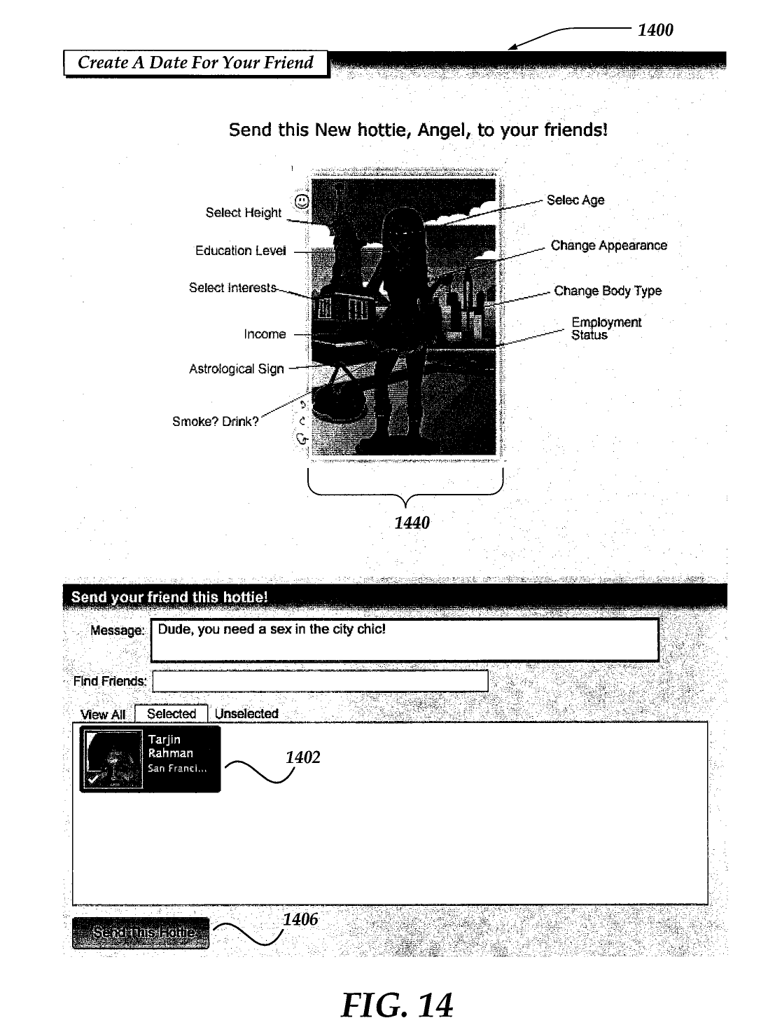

FIG. 14 illustrates one embodiment of an interface 1400 where the friend has modified the visual representation of FIG. 13 to a modified visual representation 1440, using mechanisms as described above. The friend may then send a message that includes the modified visual representation 1440, specifying for whom the search is for 1402, using the send indicator 1406. In one embodiment, the friend may also send the message including the modified visual representation to the intended search result recipient.

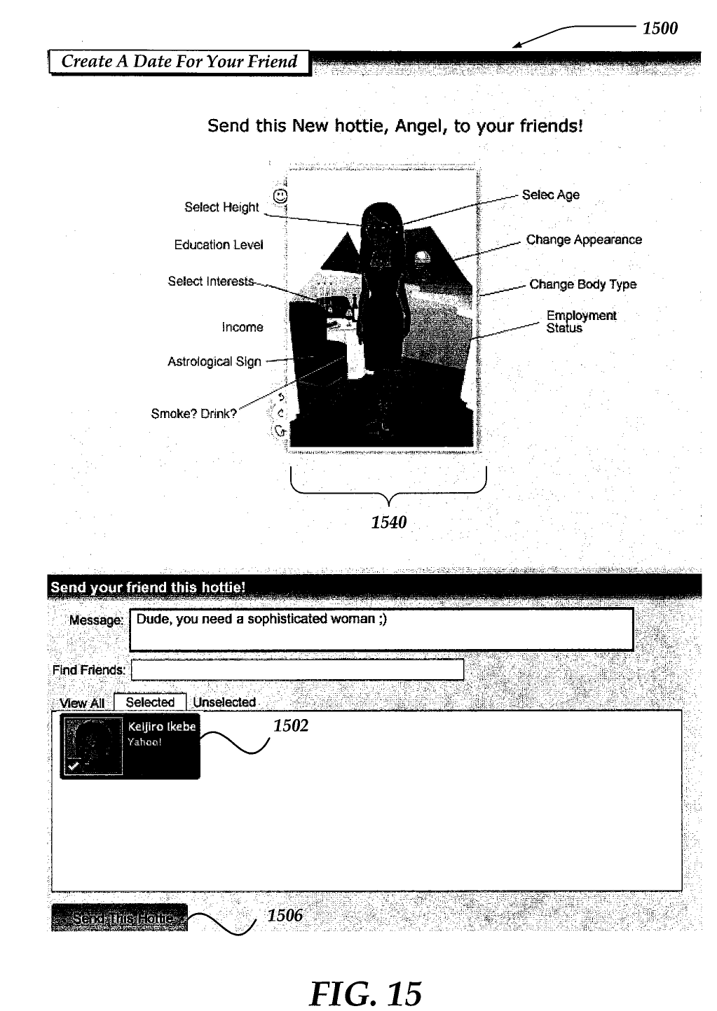

FIG. 15 illustrates another embodiment of an interface 1500 where the friend has modified the visual representation of FIG. 13 to a modified visual representation 1540, using mechanisms as described above. The friend may then send a message that includes the modified visual representation 1540, specifying for whom the search is for 1502, using the send indicator 1506. In one embodiment, the friend may also send the message including the modified visual representation to the intended search result recipient. Thus, as shown, the friend may make multiple modifications of the visual representations of search criteria, for different friends.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative to perform actions, including:
graphically displaying one or more graphical elements representing search criteria to a first friend of an intended search result recipient;
receiving selections of one or more of the graphically displayed elements representing search criteria;
generating at least a visual representation of a combination of the received one or more graphical elements;
using the one or more received search criteria associated with the visual representation to perform a search; and
providing a result of the search to the intended search result recipient.

2. The network device of claim 1, wherein the processor is operative to perform actions, further including:
receiving from the first friend a list of one or more other friends of the intended search result recipient;
sending to each of the one or more other friends in the received list, the visual representation;
allowing at least one of the other friends to visually modify the visual representation using one or more of the graphically displayed elements representing search criteria; and
for each modified visual representation by the one or more other friends:
performing another search using the one or more search criteria represented by the visual representation; and
providing each result of the other searches to the intended search result recipient.

3. The network device of claim 1, wherein the graphically elements representing the search criteria includes at least one of a physical characteristic of the visual representation, including at least a hair color, an eye color, a weight, or a height, and wherein the graphically displayed search criteria further enables at least the first friend to visually select another search criteria that visually represents at least one of an intangible search criteria.

4. The network device of claim 1, wherein the visual representation represents a dream date in at least an avatar visual form as defined by the first friend for the intended search result recipient within an online dating context.

5. The network device of claim 1, wherein the processor is operative to perform actions, further including providing the intended search result recipient a capability to terminate at least one search or receipt of at least one result of a search generated by other than the intended search result recipient.

6. The network device of claim 1, wherein the processor is operative to perform actions, further including wherein the visual representation is generated by combining graphic search criteria useable to perform a search for at least one of employment search results, a product search result, or a service search result.

7. A system that is operative to manage a search query, comprising:
a graphical user interface displayable at a client device useable to receive and to display search criteria as graphical elements; and
a network device that is configured to provide the graphical user interface to the client device and to perform actions, including:
providing to the client device, associated with a first friend of an intended search result recipient, a plurality of different graphical elements representing search criteria;
receiving selections from the first friend of one or more of the graphical elements;
generating a visual representation that includes at least an avatar by combining the graphically elements representing search criteria;
employing the visual representation of the search criteria to perform a search; and
providing a result of the search to the intended search result recipient.

8. The system of claim 7, wherein the network device is configured to perform actions, further including:
sending the visual representation, including the avatar, to at least a second friend;
receiving a second selection from the second friend of one or more of the graphical elements representing search criteria;
modifying the visual representation of the search criteria based on the received second selection;
performing another search based on the modified visual representation; and
providing a result of the other search to the intended search result recipient.

9. The system of claim 7, wherein the intended search result recipient is provided with a capability to inhibit receipt of the result of the search or a result of another search by the intended search result recipient.

10. The system of claim 7, wherein the network device is configured to perform actions, further including:
sending the visual representation of the search criteria to the intended search result recipient;
receiving a modification to the visual representation based on other selections of at least one of the graphical element representing search criteria from the intended search result recipient; and
performing another search based on the modified visual representation.

11. The system of claim 7, wherein the avatar visually represents a dream date for the intended search result recipient based on selections of the displayed search criteria by the first friend.

12. A computer-readable storage medium having computer-executable instructions, the computer-executable instructions when installed onto a computing device enable the computing device to perform actions, comprising:
graphically displaying one or more search criteria to a first friend of an intended search result recipient, the graphically displayed search criteria being visual representations of components to a dating profile;
receiving selections of one or more of the graphically displayed search criteria, wherein the selections;
generating a visual representation based on a combination of the received one or more search criteria;
using the one or more received search criteria embodied by the generated visual representation to perform a search; and
providing a result of the search to the intended search result recipient.

13. The computer-readable storage medium of claim 12, wherein the computing device perform actions, further comprising:
sending the visual representation of the search criteria to a plurality of other friends of the intended search result receipt;
generating modifications to the visual representation based on selections of other graphically displayed search criteria received from one of the plurality of other friends; and
providing another search result to the intended search result recipient based on another search performed using the modified visual representation.

14. The computer-readable storage medium of claim 12, wherein each graphically displayed search criteria is associated with at least one keyword, the at least one keyword usable to perform the search.

15. The computer-readable storage medium of claim 12, wherein the visual representation visually represents search criteria for use in performing a search for at least one of a online dating profile, a job, a product, or a service.

16. The computer-readable storage medium of claim 12, wherein the one or more graphically displayed search criteria visually represents at least one or a financial status of online dating candidate, a recreation of the online dating candidate, or a educational status of the online dating candidate.

17. A method that modifies a computing device such that the computing device is enabled to perform a search query, comprising:
graphically displaying visual elements to a user, the visual elements associated with search criteria;
receiving selections of one or more of the graphically displayed visual elements;
generating at least an avatar based on the received selections, the avatar visually representing search criteria for an online dating candidate;
receiving a selection of another user;
performing a search for the online dating candidate based on the represented search criteria; and
providing a search result to the other user.

18. The method of claim 17, further comprising:
receiving the visual representation;
determining one or more keywords associated with each of the search criteria embodied by the visual representation; and
using the one or more determined keywords to perform the search.

19. The method of claim 17, further comprising:
receiving a selection of a third user;
sending the generated avatar to the third user;
receiving modifications to the avatar based on selections by the third user of at least one other graphically displayed visual element representing at least one search criteria; and
providing a result of another search based on the modified avatar to the other user.

20. The method of claim 17, wherein generating at least the avatar further comprising generating a graphical environment for display of the avatar, the graphical environment further configured to visually represent at least one other search criteria.
